(19) United States
(12) Patent Application Publication
(10) Pub. No.: US 2005/0204313 A1
(43) Pub. Date: Sep. 15, 2005

(54) Display screen burn prevention method

(75) Inventors: Kenichi Enoki, Fukuroi-shi (JP); Hideo Naganuma, Fukuroi-shi (JP); Takashi Ohkita, Fukuroi-shi (JP); Noriyuki Kamada, Fukuroi-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 11/072,647

(22) Filed: Mar. 7, 2005

(30) Foreign Application Priority Data
Mar. 9, 2004 (JP) 2004-65210

(51) Int. Cl. G06F 17/00

(52) U.S. Cl. 715/867; 348/173

(57) ABSTRACT

The display position of an image on a display screen is gradually moved in an oblique direction in a specified display mode. Accordingly, display screen burn is prevented.

### BACKGROUND OF THE INVENTION

1. Field of the Invention

The present invention relates to a method for preventing display screen burn in image display devices.

2. Description of the Related Art

Displays such as CRTs (Cathode Ray Tubes) and plasma display panels, which make use of the photoemission phenomenon which accompanies the excitement of phosphors, are subjected to degradation of the phosphors and so-called screen burn when a still image is continuously displayed for a long period of time.

In order to prevent such screen burn, a screen burn prevention method is proposed in Japanese Patent Kokai (Laid-open Application) No. 2000-227775. This method forces gradual movement of the display position of a displayed object on a screen over time.

With this screen burn prevention method, first the object displayed in a still image is gradually moved horizontally to the right in one dot increments for five dots. Next, the object displayed is moved vertically just one dot from this position, and then gradually moved horizontally to the left in one dot increments for five dots. Subsequently, the displayed object is moved in the vertical direction for one dot. The aforementioned series of movements is repeatedly performed. In other words, by alternately repeating the action of gradually horizontally moving the object displayed in a still image and the action of vertically moving the displayed object by just one dot, the still image display on the screen is moved, and screen burn is prevented.

However, with these actions for preventing screen burn, the following problems occur if “tables” which contain ruled lines extending in the horizontal direction and vertical direction of the screen are displayed as the still image. Namely, ruled lines which extend in the horizontal direction are displayed fixed in the same screen position during movement in the horizontal direction, and similarly, ruled lines which extend in the vertical direction are displayed fixed in the same screen position during movement in the vertical direction.

Therefore, the screen burn cannot completely be prevented by these screen burn preventing actions.

### SUMMARY OF THE INVENTION

An object of the present invention is to provide a display screen burn preventing method which can effectively prevent display screen burns.

According to a first aspect of the present invention, there is provided an improved method for preventing display screen burn of a display device. The display device displays images corresponding to an input image signal. When the display device is operated in a certain mode, the display screen burn prevention method applies a unique display position moving process which gradually moves the display position of the image in an oblique direction in the display screen.

In one of preferred embodiments, the display position moving process imposes the still image to move spirally.

Preferably, the display position moving process moves the display position of the image by an amount of one pixel at predetermined intervals. The display position of the image may return to an original position each time a total amount of movements reaches two or more pixels. The display device may be a plasma display device.

### BRIEF DESCRIPTION OF THE DRAWINGS

FIG. 1 is a block diagram showing the structure of a display device with a screen burn prevention function according to one embodiment of the present invention;

FIG. 2A illustrates an arrangement of pixels on a display screen of the display device shown in FIG. 1;

FIG. 2B illustrates a memory space in a first frame memory of the display device shown in FIG. 1, which has memory block numbers corresponding to the pixel positions shown in FIG. 2A;

FIG. 2C illustrates a memory space in a second frame memory of the display device shown in FIG. 1, which has memory block numbers corresponding to the pixel positions shown in FIG. 2A;

FIG. 3 is a flowchart of a display position movement process (routine) performed by a display position movement control circuit of the display device shown in FIG. 1;

FIG. 4 shows an example of a travel path of one pixel of image on the display screen when the display position movement process is performed;

FIG. 5 shows another example of a travel path of one pixel of image on the display screen;

FIG. 6 shows still another example of a travel path of one pixel of image on the display screen;

FIG. 7 shows yet another example of a travel path of one pixel of image on the display screen;

FIG. 8 shows another example of a travel path of one pixel of image on the display screen; and

FIG. 9 is a block diagram of another display device having a screen burn prevention function.

### DETAILED DESCRIPTION OF THE INVENTION

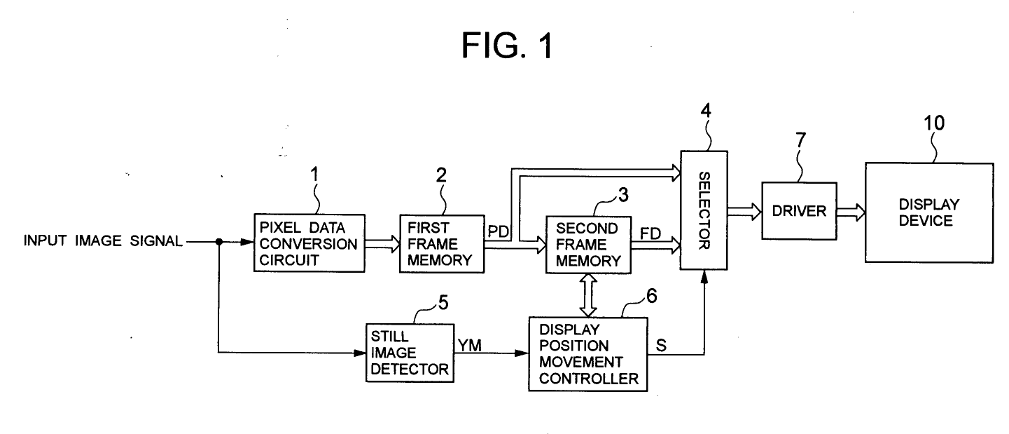

Referring to FIG. 1, a structure of a display device 10 with a display screen burn prevention function will be described.

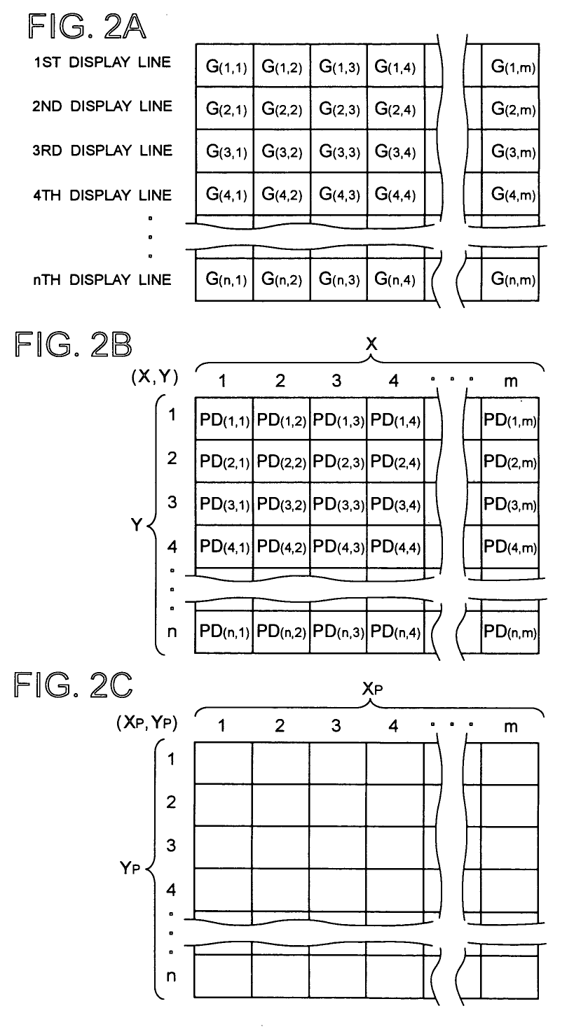

In FIG. 1, a display device 10 is a CRT (Cathode Ray Tube) or a plasma display panel or the like, and pixels G_{(1,1)}-G_{(n,m)} are arranged as shown in FIG. 2A in this screen (n rows×m columns). Each of the pixels G_{(1,1)}-G_{(n,m)} is actually a combination of three pixels. The three pixels are a red pixel G_{R} which emits red light, a green pixel G_{G} which emits green light, and a blue pixel G_{B} which emits blue light. A driver 7 is connected to the display device 10.

An input image signal is introduced to a pixel data converter circuit 1 and a still image detection circuit 5. The pixel data converter circuit 1 is connected to a first frame memory 2. The first frame memory 2 is connected to a second frame memory 3 and a selector 4. The selector 4 is connected to the display device driver 7. The still image detection circuit 5 is connected to a display position movement controller 6. Th second frame memory 3 is also connected to the display position movement controller 6. The second frame memory 3 and display position movement controller 6 are also connected to the selector 4.

The pixel data converter circuit 1 converts the input image signal to pixel data PD_{(1,1)}-PD_{(n,m)} which correspond to the pixels G_{(1,1)}-G_{(n,m)} of display device 10, respectively. The pixel data converter circuit 1 successively sends the pixel data PD_{(1,1)}-PD_{(n,m)} to the first frame memory 2. The pixel data PD is, for instance, eight bits of data showing an individual level of brightness for each of the red pixel G_{R}, green pixel G_{G}, and blue pixel G_{B}. For instance, the pixel data PD_{(1,1)} of the first row first column pixel G_{(1,1)} expresses in eight bits the brightness level when the red pixel G_{R(1,1)} is emitting, the brightness level when the green pixel G_{G(1,1)} is emitting, and the brightness level when the blue pixel G_{B(1,1)} is emitting. The first frame memory 2 stores the pixel data PD_{(1,1)}-PD_{(n,m)} for one screen in addresses (X,Y) corresponding to pixel positions of the display device 10 as shown in FIG. 2B. “X” corresponds to the “row” of the display device 10, and “Y” corresponds to the “column” of the display device 10. For instance, the pixel data PD_{(1,1)} of the first row first column pixel G_{(1,1)} is recorded in the address (1,1) of the first frame memory 2, and the pixel data PD_{(1,m)} of the first row mth column pixel G_{(1,m)} is recorded in the address (1,m) of the first frame memory 2. The first frame memory 2 reads one frame worth of pixel data PD_{(1,1)}-PD_{(n,m)} recorded as shown in FIG. 2B in order of PD_{(1,1)}-PD_{(1,m)} corresponding to the first display line, PD_{(2,1)}-PD_{(2,m)} corresponding to the second display line, PD_{(3,1)}-PD_{(3,m)} corresponding to the third display line, . . . , and PD_{(n,1)}-PD_{(n,m)} corresponding to the nth display line, and provides these data to the second frame memory 3 and selector 4.

The still image detection circuit 5 determines, based on the input image signal, whether or not the image to be displayed is a still image. If the still image detection circuit 5 determines that the image expressed by the input image signal is a still image, and confirms that one frame worth of the input image signal for this still image does not change over a predetermined period of time, then the still image detection circuit 5 sends a still image mode signal YM to the display position movement control circuit 6. The still image mode signal YM indicates that the display device 10 should be operated in a still image mode.

The display position movement control circuit 6 executes reading and writing operations to the second frame memory 3 in accordance with a display position movement process (described later), and provides a selection signal S to the selector 4.

The second frame memory 3 has memory space corresponding to the pixel positions of the display device 10 as shown in FIG. 2C. “X_{P}” corresponds to the “row” of the display device 10 and “Y_{P}” corresponds to the “column” of the display device 10. One frame worth of pixel data PD_{(1,1)}-PD_{(n,m)} is written (recorded) in the second frame memory 3 in accordance with the write controls (discussed later) from the display position movement control circuit 6. The second frame memory 3 successively reads in increments of one display line the recorded pixel data PD_{(1,1)}-PD_{(n,m)} depending on the read controls (discussed later) from the display position movement control circuit 6. The second frame memory 3 sends the pixel data PD_{(1,1)}-PD_{(n,m)} to the selector 4 as position change pixel data FD_{(1,1)}-FD_{(n,m)}.

The selector 4 selects either the position change pixel data FD or the pixel data PD based on the selection signal S, and sends the selected data to the driver 7. The selection signal S has a logic level 1 or 0. The logic level 1 selection signal instructs a screen burn prevention action. If the selector 4 receives the logic level 1 selection signal, the selector 4 sends the position change pixel data FD to the driver 7. If the selector 4 receives the logic level 0 selection signal, the selector 4 supplies the pixel data PD to the driver 7. The driver 7 generates and provides to the display device 10 various drive signals to display an image corresponding to the pixel data provided from the selector 4. The display device 10 displays an image corresponding to the drive signal sent from the driver 7.

The detailed function of the display position movement control circuit 6 will be described below.

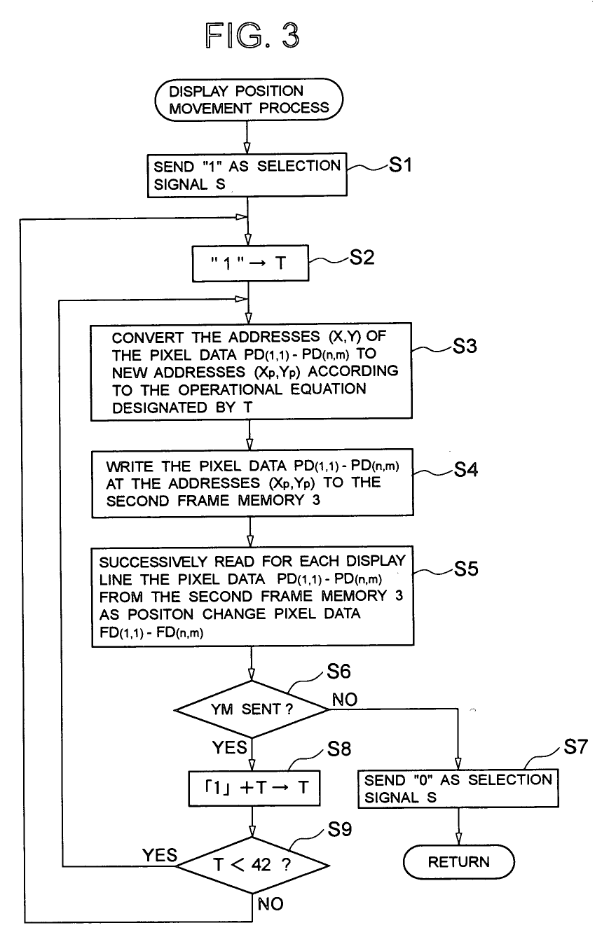

The display position movement control circuit 6 begins a control function in accordance with the display position movement process (routine) as shown in FIG. 3 when the still image mode signal YM is provided from the still image detector circuit 5.

Referring to FIG. 3, first, the display position movement control circuit 6 sends a logic level 1 selection signal S to the selector 4 (Step S1). Then, the selector 4 sends the position change pixel data FD sent from the second frame memory 3 to the driver 7. Next, the display position movement control circuit 6 writes “1” to an internal register (not shown in the drawings) as the initial value for an operational equation designating value T (Step S2). Next, the display position movement control circuit 6 uses the operational equation designated by the operational equation designating value T, and converts the addresses (X,Y) of the pixel data PD_{(1,1)}-PD_{(n,m)} recorded in the first frame memory 2 (FIG. 2B) to new addresses (X_{P},Y_{P}) (Step S3). If the operational equation designating value T is between “1” and “41”, the operational equation is selected as shown below.
T=“1”: (X_{P}, Y_{P})=(X−1, Y+1)
T=“2”: (X_{P}, Y_{P})=(X, Y+2)
T=“3”: (X_{P}, Y_{P})=(X+1, Y+1)
T=“4”: (X_{P}, Y_{P})=(X+2, Y)
T=“5”: (X_{P}, Y_{P})=(X+1, Y−1)
T=“6”: (X_{P}, Y_{P})=(X, Y−2)
T=“7”: (X_{P}, Y_{P})=(X−1, Y−1)
T=“8”: (X_{P}, Y_{P})=(X−2, Y)
T=“9”: (X_{P}, Y_{P})=(X−3, Y+1)
T=“10”: (X_{P}, Y_{P})=(X−2, Y+2)
T=“11”: (X_{P}, Y_{P})=(X−1, Y+3)
T=“12”: (X_{P}, Y_{P})=(X, Y+4)
T=“13”: (X_{P}, Y_{P})=(X+1, Y+3)
T=“14”: (X_{P}, Y_{P})=(X+2, Y+2)
T=“15”: (X_{P}, Y_{P})=(X+3, Y+1)
T=“16”: (X_{P}, Y_{P})=(X+4, Y)
T=“17”: (X_{P}, Y_{P})=(X+3, Y−1)
T=“18”: (X_{P}, Y_{P})=(X+2, Y−2)
T=“19”: (X_{P}, Y_{P})=(X+1, Y−3)
T=“20”: (X_{P}, Y_{P})=(X, Y−4)
T=“21”: (X_{P}, Y_{P})=(X−1, Y−3)
T=“22”: (X_{P}, Y_{P})=(X−2, Y−2)
T=“23”: (X_{P}, Y_{P})=(X−3, Y−1)
T=“24”: (X_{P}, Y_{P})=(X−4, Y)
T=“25”: (X_{P}, Y_{P})=(X−3, Y)
T=“26”: (X_{P}, Y_{P})=(X−2, Y+1)
T=“27”: (X_{P}, Y_{P})=(X−1, Y+2)
T=“28”: (X_{P}, Y_{P})=(X, Y+3)
T=“29”: (X_{P}, Y_{P})=(X+1, Y+2)
T=“30”: (X_{P}, Y_{P})=(X+2, Y+1)
T=“31”: (X_{P}, Y_{P})=(X+3, Y)
T=“32”: (X_{P}, Y_{P})=(X+2, Y−1)
T=“33”: (X_{P}, Y_{P})=(X+1, Y−2)
T=“34”: (X_{P}, Y_{P})=(X, Y−3)
T=“35”: (X_{P}, Y_{P})=(X−1, Y−2)
T=“36”: (X_{P}, Y_{P})=(X−2, Y−1)
T=“37”: (X_{P}, Y_{P})=(X−1, Y)
T=“38”: (X_{P}, Y_{P})=(X, Y+1)
T=“39”: (X_{P}, Y_{P})=(X+1, Y)
T=“40”: (X_{P}, Y_{P})=(X, Y−1)
T=“41”: (X_{P}, Y_{P})=(X, Y)

Next, the display position movement control circuit 6, using the new addresses (X_{P},Y_{P}), writes the pixel data PD_{(1,1)}-PD_{(n,m)} in these addresses to the second frame memory 3 (Step S4). Next, the display position movement control circuit 6 successively reads for each display line the pixel data PD_{(1,1)}-PD_{(n,m)} from the second frame memory 30, and sends this to the selector 4 as the position change pixel data FD_{(1,1)}-FD_{(n,m)} (Step S5). By the execution of Step S5, the pixel data PD is successively read in order of PD_{(1,1)}-PD_{(1,m)} corresponding to the first display line, PD_{(2,1)}-PD_{(2,m)} corresponding to the second display line, . . . , PD_{(n,1)}-PD_{(n,m)} corresponding to the nth display line, and this data is sent to the display device driver 7 via the selector 4 as position change pixel data FD_{(1,1)}-FD_{(n,m)}. Therefore, an image is displayed on the screen of the display device 10 based on the position change pixel data FD_{(1,1)}-FD_{(n,m)}. Next, the display position movement control circuit 6 determines whether or not the still image mode signal YM is sent from the still image detection circuit 5 (Step S6). If it is determined in Step S6 that the still image mode signal YM is not received, the display position movement control circuit 6 sends a logical level 0 selection signal S to the selector 4 (Step S7). Then, the selector 4 sends the pixel data PD sent from the first frame memory 2 to the driver 7. In other words, if the still image mode signal YM is not received, the image is displayed on the screen of the display device 10 based on the pixel data PD_{(1,1)}-PD_{(n,m)}. After Step S7, the display position movement control circuit 6 exits the display position movement process and returns to executing a main routine (not described). On the other hand, if it is determined in Step S6 that the still image mode signal YM is received, the display position movement control circuit 6 adds “1” to the operational equation designating value T in the internal register and overwrites this new value into the internal register as the new operational equation designating value T (Step S8). Next, the display position movement control circuit 6 determines whether or not the operational equation designating value T written in the internal register is smaller than “42” (Step S9). If the operational equation designating value T is determined to be smaller than “42” in Step S9, the display position movement control circuit 6 returns to Step S3 and repeats the aforementioned actions. On the other hand, if the operational equation designating value T is determined to be equal to or larger than “42”, the display position movement control circuit 6 returns to Step S2, and repeats the aforementioned actions. In other words, the actions of Step S3 through Step S8 are repeatedly executed while the operational equation designating value T increases from “1” through “41”, and if the operational equation designating value T reaches or exceeds “42”, the operational equation designating value T is returned to “1” and the aforementioned actions are repeatedly executed.

The still image, derived from one frame worth of pixel data PD_{(1,1)}-PD_{(n,m)}, slightly moves in a helical pattern on the screen of the display device 10 each time the series of controls from Step S3 through Step S5 is executed.

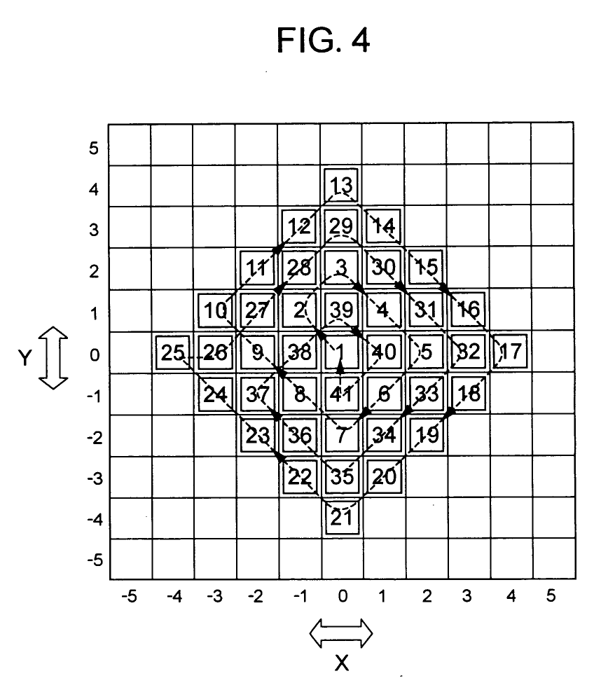

FIG. 4 is a diagram which focuses only on a single pixel in the whole image and expresses in steps (1 through 41) the process of moving the single pixel on the screen of display device 10. In FIG. 4, the first position (X,Y), which is the starting point for the movement of the single pixel, is (0,0).

First, the one pixel image moves to the second position (−1, 1) by means of Step S3 through Step S5 when the operational equation designating value T is “1”. Next, the one pixel image moves to the third position (0, 2) by means of Step S3 through Step S5 when the operational equation designating value T is “2”. Next, the one pixel image moves to the fourth position (1, 1) by means of Step S3 through Step S5 when the operational equation designating value T is “3”.

Similarly, the one pixel image gradually moves to the following positions as shown in FIG. 4 by means of Step S3 through Step S5 when the operational equation designating value T is increased from “4” to “41”: fifth position (2, 0), sixth position (1, −1), seventh position (0, −2), eighth position (−1, −1), ninth position (−2, 0), tenth position (−3, 1), eleventh position (−2, 2), twelfth position (−1, 3), thirteenth position (0, 4), fourteenth position (1, 3), fifteenth position (2, 2), sixteenth position (3, 1), seventeenth position (4, 0), eighteenth position (3, −1), nineteenth position (2, −2), twentieth position (1, −3), twenty-first position (0, −4), twenty-second position (−1, −3), twenty-third position (−2, −2), twenty-fourth position (−3, −1), twenty-fifth position (−4, 0), twenty-sixth position (−3, 0), twenty-seventh position (−2, 1), twenty-eighth position (−1, 2), twenty-ninth position (0, 3), thirtieth position (1, 2), thirty-first position (2, 1), thirty-second position (3, 0), thirty-third position (2, −1), thirty-fourth position (1, −2), thirty-fifth position (0, −3), thirty-sixth position (−1, −2), thirty-seventh position (−2, −1), thirty-eighth position (−1, 0), thirty-ninth position (0, 1), fortieth position (1, 0), and forty-first position (0, −1). After the forty-first position, the image returns to the first position (0, 0).

In other words, if an input image signal is given which maintains an identical still image exceeding a specified time period (i.e., if the screen burn prevention mode is entered), the still image is gradually moved in an oblique direction on the screen so as to form a helical travel path as shown in FIG. 4 on the display screen of display device 10.

Therefore, even if “tables” including ruled lines extending in the horizontal and vertical directions of the screen are displayed as still images, these ruled lines continuously move in various (non-overlapping) directions on the screen so that screen burn is prevented.

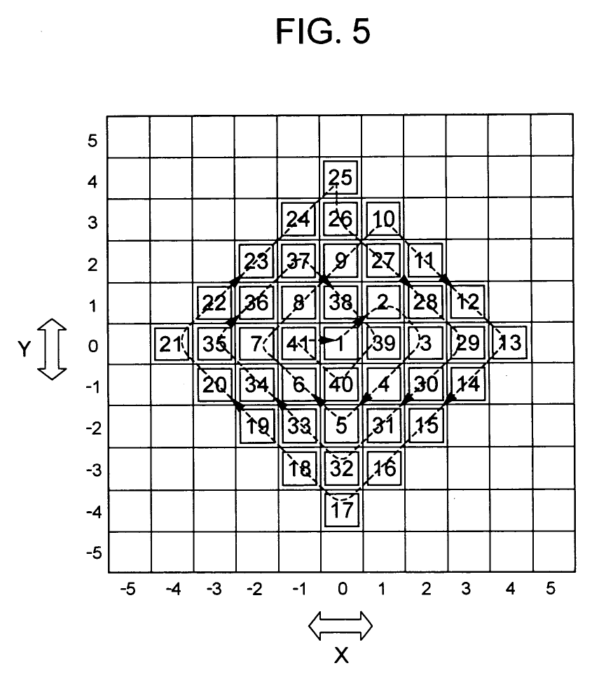

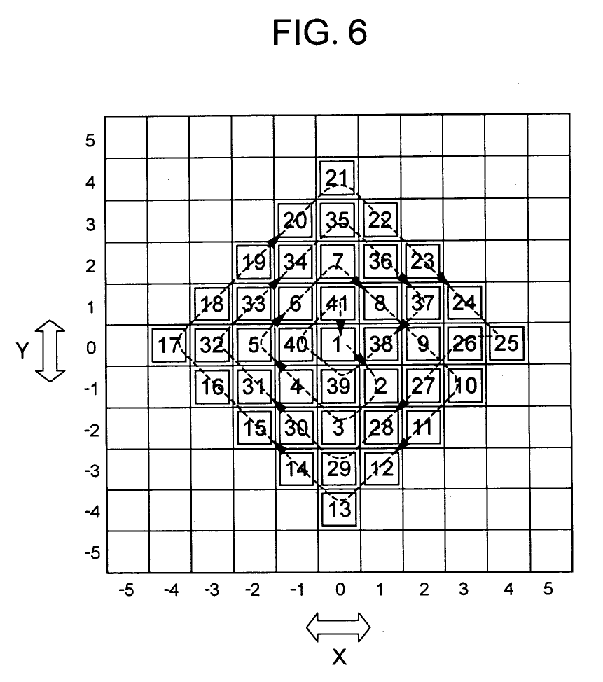

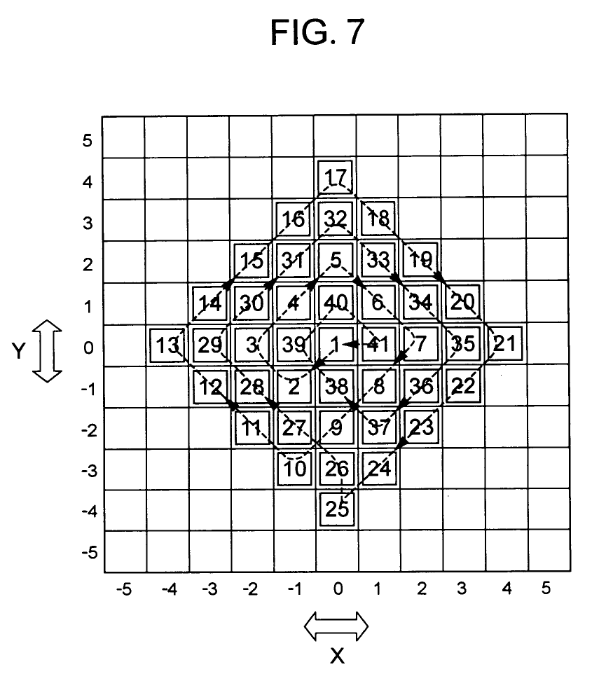

It should be noted that FIG. 4 is not a restriction, and it is also acceptable for the still image to be continuously moved in a helical pattern in one pixel increments in various oblique directions as shown in FIG. 5, FIG. 6, or FIG. 7.

For instance, in FIG. 5, the one pixel image is first moved from the first position (0, 0) to the second position (1, 1) and thereafter to the third position (2, 0), fourth position (1, −1), fifth position (0, −2), sixth position (−1, −1), seventh position (−2, 0), eighth position (−1, 1), ninth position (0, 2), tenth position (1, 3), eleventh position (2, 2), twelfth position (3, 1), thirteenth position (4, 0), fourteenth position (3, −1), fifteenth position (2, −2), sixteenth position (1, −3), seventeenth position (0, −4), eighteenth position (−1, −3), nineteenth position (−2, −2), twentieth position (−3, −1), twenty-first position (−4, 0), twenty-second position (−3, 1), twenty-third position (−2, 2), twenty-fourth position (−1, 3), twenty-fifth position (0, 4), twenty-sixth position (0, 3), twenty-seventh position (1, 2), twenty-eighth position (2, 1), twenty-ninth position (3, 0), thirtieth position (2, −1), thirty-first position (1, −2), thirty-second position (0, −3), thirty-third position (−1, −2), thirty-fourth position (−2, −1), thirty-fifth position (−3, 0), thirty-sixth position (−2, 1), thirty-seventh position (−1, 2), thirty-eighth position (0, 1), thirty-ninth position (1, 0), fortieth position (0, −1), and forty-first position (−1, 0). After the forty-first position, the image returns to the first position (0, 0).

In FIG. 4 through FIG. 7, the still image is moved in a clockwise helical pattern, but moving in a counterclockwise direction is also acceptable.

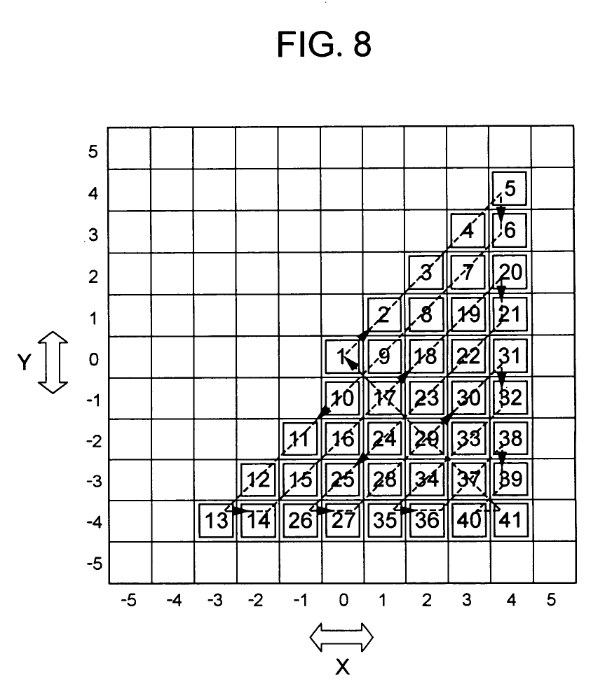

It is also acceptable to move the still image in an oblique direction of one pixel increments so as to form a zigzag travel path as shown in FIG. 8.

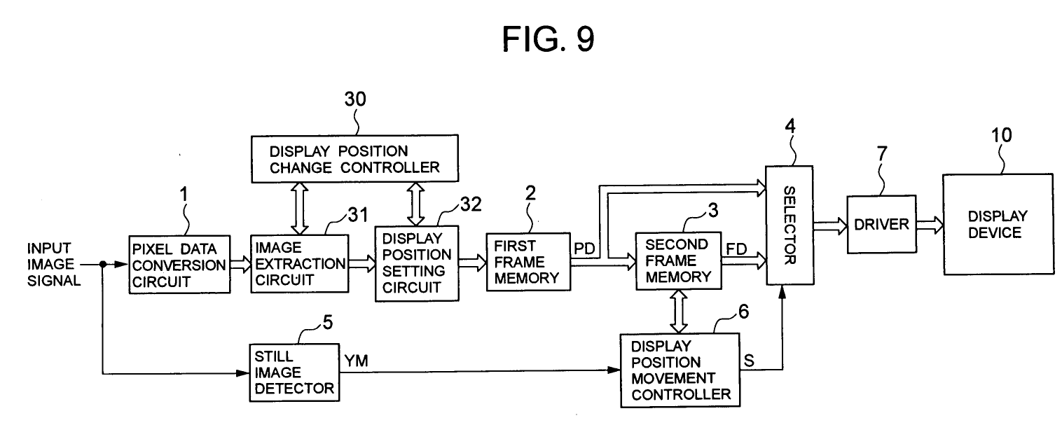

In the above described embodiment, the whole single frame worth of image derived from the input image signal is moved, but it is also acceptable to move a certain part of the single frame worth of image. This modification will be described with reference to FIG. 9.

FIG. 9 illustrates a structure of a modified display device arrangement.

The structure shown in FIG. 9 is identical to that shown in FIG. 1 except for the display position change control circuit 30, image extraction circuit 31, and display position setting circuit 32, so the description of the already described structure is omitted below. The pixel data converter circuit 1 is connected to the image extraction circuit 31. The image extraction circuit 31 is connected to the display position setting circuit 32. The display position change control circuit 30 is connected to the image extraction circuit 31 and the display position setting circuit 32. The display position setting circuit 32 is connected to the first frame memory 2. Similar reference numerals and symbols are used to designate similar elements and signals in FIG. 1 and FIG. 9.

In FIG. 9, a single frame worth of pixel data PD_{(1,1)}-PD_{(n,m)} is supplied to the image extraction circuit 31 from the image data conversion circuit 1. Then, a certain part (or certain image region) in the image is specified by the display position change control circuit 30. The image extraction circuit 31 extracts only the pixel data PD of the pixels existing within the specified image region from the pixel data PD_{(1,1)}-PD_{(n,m)}, and sends the extracted pixel data to the display position setting circuit 32. In the meantime, the image position change control circuit 30 sends a display region designating signal to the display position setting circuit 32. The display region designating signal designates a display region on the screen of the display device 10 to display the image expressed by the extracted pixel data PD. The display position setting circuit 32 generates a new single frame worth of pixel data from the extracted pixel data PD by making correspondence between the extracted pixel data PD and the pixels in the display region designated by the display region designating signal, and sends this data to the first frame memory 2. A user decides the size of the image to be extracted. In other words, the display position change control circuit 30 acquires instructions from the user to specify the image region. The user also decides the display region on the screen of the display device 10 for the extracted image. The display position change control circuit 30 receives instructions from the user to designate the display region on the display screen.

Therefore, with the structure shown in FIG. 9, a specific image can be displayed moving as shown in FIG. 4 through FIG. 8 in an arbitrary (or desired) area on the display screen of display device 10.

This application is based on a Japanese Patent Application No. 2004-65210 filed on Mar. 9, 2004, and the entire disclosure thereof is incorporated herein by reference.

1. A display screen burn prevention method which prevents burning of a display screen of a display device, the display device being adapted to display an image corresponding to an input image signal, said method comprising:
a display position moving process which gradually moves in an oblique direction a display position of said image in said display screen in a predetermined display mode.

2. The display screen burn prevention method according to claim 1, wherein said predetermined display mode is a still image display mode which displays a still image on said display screen.

3. The display screen burn prevention method according to claim 1, wherein said display position moving process moves the display position of said image by an amount of one pixel at each predetermined interval.

4. The display screen burn prevention method according to claim 3, wherein said display position moving process moves the display position of said image such that the display position of said image returns to an original position each time a total amount of movements reaches N pixels (where N is an integer greater than one).

5. The display screen burn prevention method according to claim 4, wherein said N is equal to 41.

6. The display screen burn prevention method according to claim 1, wherein said display device is a plasma display device or a cathode ray tube display device.

7. The display screen burn prevention method according to claim 1, wherein said display position moving process moves the display position of said image such that a travel path of the display position of said image forms a helical pattern.

8. The display screen burn prevention method according to claim 1, wherein said display position moving process moves a display position of a certain part of said image in the oblique direction.

9. An apparatus for preventing burning of a display screen of a display device, comprising:
first means for determining whether an image to be displayed on the display screen is a still image; and
second means for gradually moving the image in an oblique direction on the display screen when the second means determines that the image to be displayed is a still image.

10. The apparatus for preventing burning of a display screen of a display device according to claim 9, wherein the second means moves the image by an amount of one pixel at each predetermined interval.

11. The apparatus for preventing burning of a display screen of a display device according to claim 10, wherein the second means moves the image such that the image returns to an original position when a total amount of movements reaches N pixels (where N is an integer greater than one).

12. The apparatus for preventing burning of a display screen of a display device according to claim 11, wherein said N is equal to 41.

13. The apparatus for preventing burning of a display screen of a display device according to claim 9, wherein said display device is a plasma display device or a cathode ray tube display device.

14. The apparatus for preventing burning of a display screen of a display device according to claim 9, wherein the second means moves the image in a helical pattern.

15. The apparatus for preventing burning of a display screen of a display device according to claim 9, wherein the second means moves a certain part of the image in the oblique direction.
